(19) United States
(12) Patent Application Publication
(10) Pub. No.: US 2023/0371625 A1
(43) Pub. Date: Nov. 23, 2023

(54) PROTECTIVE FACE MASK WITH POSITIVE AIR PRESSURE

(71) Applicant: Raja Singh Tuli, Montreal (CA)

(72) Inventor: Raja Singh Tuli, Montreal (CA)

(21) Appl. No.: 18/197,942

(22) Filed: May 16, 2023

Related U.S. Application Data
(60) Provisional application No. 63/342,701, filed on May 17, 2022.

(51) Int. Cl. A41D 13/11; A62B 7/10

(52) U.S. Cl. CPC A41D 13/1161; A41D 13/1138; A62B 7/10

(57) ABSTRACT

A protective face mask e.g. for protection from airborne contaminants is provided, which comprises a mask body configured to cover a portion of a wearer's face; securing means configured to secure the protective face mask to the head of the wearer; and an intake unit configured to draw air into the space between the inner side of the mask body of the protective face mask and the wearer's face to maintain a positive air pressure in the space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to a protective face mask, and more particularly, to a protective face mask with positive air pressure.

### Description of Related Art

Protective face masks are used in a wide variety of applications to protect the wearers from inhaling airborne contaminants, such as particles suspended in the air, powders, solid and liquid aerosols, as well as germs.

Also, many of the germs that cause respiratory diseases are spread by droplets that come from coughing and sneezing. These germs usually spread from person to person when uninfected persons are in close contact with a sick person. In order for protection from the potential respiratory diseases, protective face masks are worn to cover at least a part of the face (at least e.g. nose and mouth).

Presently, it is known that protective face masks can protect the wearer by disallowing airborne contaminants from entering the wearer's respiratory system. In order for a best protection, a protective face mask is expected to fit and sealed against the wearer's face so as to prevent the airborne contaminants from getting into the mask and being inhaled by the wearer. However, it is impossible, or at least difficult to make a protective face mask to perfectly fit and seal against the wearer's face, because the face's natural contours (e.g. face shapes, face size, nose bridges, mouth outlines) vary from one person to another.

On the other hand, some users wearing a protective face mask might feel uncomfortable or even get sick when the protective face mask is worn tightly to her/his face or when the edge of the protective face mask keeps touching her/his face all the time.

Thus, it is desirable to provide a protective face mask that can efficiently prevent airborne contaminants from being inhaled, without tight or close contact between its edge and a wearer's face.

### BRIEF SUMMARY OF THE INVENTION

Embodiments are presented herein of, inter alia, a protective face mask with positive air pressure.

In an embodiment of the present disclosure, a protective face mask e.g. for protection from airborne contaminants is provided, which comprises a mask body configured to cover a portion of a wearer's face; securing means configured to secure the protective face mask to the head of the wearer; and an intake unit configured to draw air into the space between the inner side of the mask body of the protective face mask and the wearer's face to maintain a positive air pressure in the space.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The various preferred embodiments of the present invention described herein can be better understood by those skilled in the art when the following detailed description is read with reference to the accompanying drawings. The components in the figures are not necessarily drawn to scale and any reference numeral identifying an element in one drawing will represent the same element throughout the drawings. The figures of the drawing are briefly described as follows.

FIG. 1 is a schematic diagram of a front elevational view of a protective face mask, according to an embodiment of the present disclosure.

FIG. 2 is a schematic diagram of a perspective view of the face of a wearer with a protective face mask shown in place thereon, according to an embodiment of the present disclosure.

FIG. 3 is a schematic diagram of a front elevational view of a protective face mask with positive air pressure, according to an embodiment of the present disclosure.

FIG. 4 depicts an exemplary graph of the flow rate of breathing (inhalation and exhalation) pattern or profile of a user wearing a protective face mask, according to an embodiment of the present disclosure.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE INVENTION

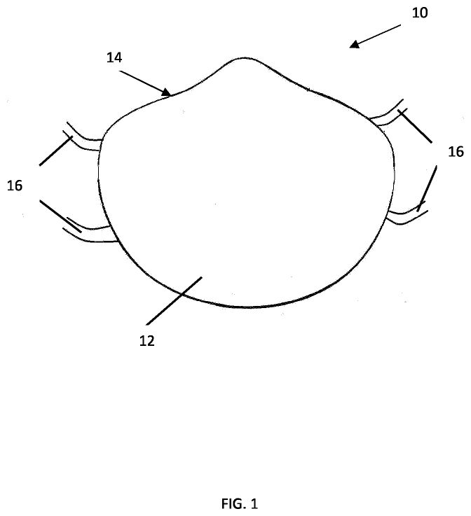

FIG. 1 illustrates a protective face mask 10 according to an embodiment of the present disclosure, which is mainly comprised of a mask body 12 and a tie band or string 16. The mask body 12 is configured to cover a portion of the wearer's face e.g. the wearer's nose and mouth, and has a mask perimeter edge 14. When a protective face mask 10 is worn by a wearer, its mask perimeter edge 14 is configured to conform to and contact the wearer's face. The tie band or string 16 is configured to secure the protective face mask 10 to the head of the wearer.

It is appreciated that the protective face mask e.g. 10 according to an exemplary embodiment of the present disclosure may be soft like disposable face mask. Alternatively, the protective face mask e.g. 10 according to an exemplary embodiment of the present disclosure may be relatively rigid to keep its shape when not under stress but also sufficiently deformable to be shaped by pressure to conform to the contour of the wearer's face.

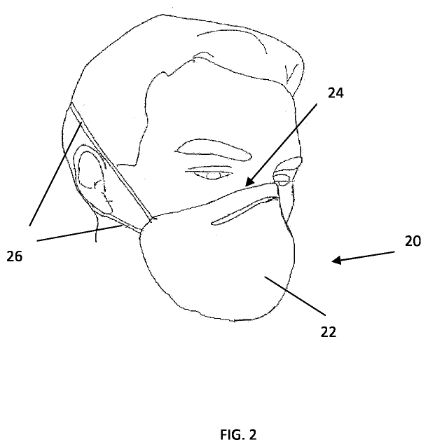

FIG. 2 is a schematic diagram of a perspective view of the face of a wearer with a protective face mask shown in place thereon, according to an embodiment of the present disclosure. As shown in FIG. 2, a protective face mask 20 is positioned in place on the head of a wearer with aid of a tie band or string 26, covering the nose and mouth of the wearer. The mask perimeter edge 24 lies in contact with the wearer's face at e.g. the wearer's nose bridge, chin, cheeks.

It is understood that, without additional seal such as rubber cushion along the mask perimeter edge 24, no airtightness will be created between the mask perimeter edge 24 and the wearer's face, which allows airborne contaminants to get into the protective face mask 20 (i.e. into the space between the inner side of the mask body 22 of the protective face mask 20 and the wearer's face) and consequently potentially enter the wearer's respiratory system.

Also it is understood that, some users wearing a protective face mask feels uncomfortable or even might get sick when the protective face mask is worn tightly to her/his face or when the edge of the protective face mask keeps touching her/his face all the time.

In order to prevent airborne contaminants from getting into the space between the inner side of the mask body of a protective face mask and the wearer's face while avoiding or minimizing the potential sickness and uncomfortableness, there remains gap between the mask perimeter edge of the protective face mask and the wearer's face, and a positive air pressure is maintained in the protective face mask in use (i.e. in the space between the inner side of the mask body of the protective face mask and the wearer's face), which makes environment air (and thus also the airborne contaminants) impossible to get into that space through the gap between the mask perimeter edge and the wearer's face, according to an exemplary embodiment of the present disclosure. In this exemplary embodiment, even when the wearer is breathing in or inhaling, the positive air pressure is maintained inside the protective face mask in use (i.e. in the space between the inner side of the mask body of the protective face mask and the wearer's face), which forces the environment air out of the protective face mask.

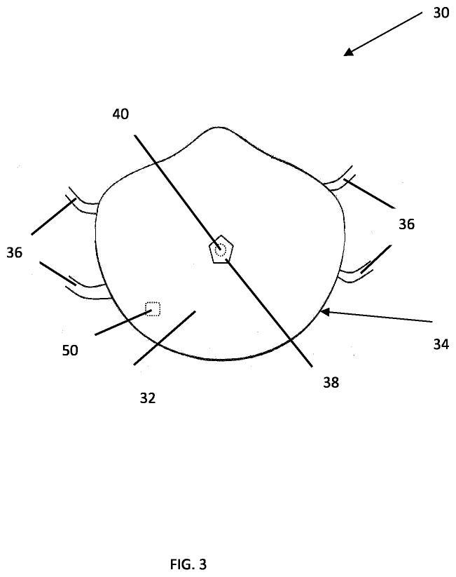

In an exemplary embodiment of the present disclosure, an intake unit may be provided on the protective face mask, which draws air into the space between the inner side of the mask body of the protective face mask and the wearer's face and thereby maintain a positive air pressure in that space. As an example and as illustrated in FIG. 3, an intake unit 38 may be provided in the center of the mask body 32 of a protective face mask 30, according to an exemplary embodiment of the present disclosure. It is to be appreciated that, the intake unit does not have to be provided in the center of the mask body, instead it can be provided at any location on the mask body, e.g. on the side or the bottom.

Preferably, the intake unit 38 may be provided with a filter 40 and is configured to draw air from outside environment into the space between the inner side of the mask body 32 of the protective face mask 30 and the wearer's face and thereby maintain a positive air pressure in that space, according to an exemplary embodiment of the present disclosure. In an exemplary embodiment, the intake unit 38 is configured to draw air directly from outside environment, which is then filtered by the filter 40 provided in the intake unit 38, and then the filtered clean air is blown or forced into the space between inner side of the mask body 32 of the protective face mask 30 and the wearer's face, thereby a positive air pressure is maintained in that space, and no unfiltered air from outside environment can get into that space through the gap between the mask perimeter edge 34 of the mask body 32 of the protective face mask 30 and the wearer's face, so the wearer is protected from airborne contaminants.

According to an exemplary embodiment, the intake unit 38 provided on a protective face mask 30 is configured to draw air into the space between the inner side of the mask body 32 of the protective face mask 30 and the wearer's face only when the wearer is breathing in or inhaling. On the other hand, when the wearer is breathing out or exhaling, the intake unit 38 stops working or does not draw air, in which situation a positive air pressure is still maintained in the protective face mask because of the air exhaled from the wearer.

In an embodiment of the present disclosure, the intake unit 38 provided on a protective face mask 30 is configured to draw air into the space between the inner side of the mask body 32 of the protective face mask 30 and the wearer's face based on the prediction on the start of the wearer's inhalation, in order to eliminate or minimize the potential delay.

It is to be appreciated that the prediction on the start of the wearer's inhalation may be performed in a variety of manners. As an example, the start of the wearer's inhalation may be predicted based on the preceding exhalation pattern or profile, which example is based on the following two factors: (1) it is understood that, when exhaling, one starts exhalation with a slow flow rate, then exhales faster, and faster, reaching a maximum flow rate, and then the flow rate slows down gradually until to a point when the exhalation ends, and (2) it is realized that the one is going to start breathing in or inhaling when her/his exhalation ends.

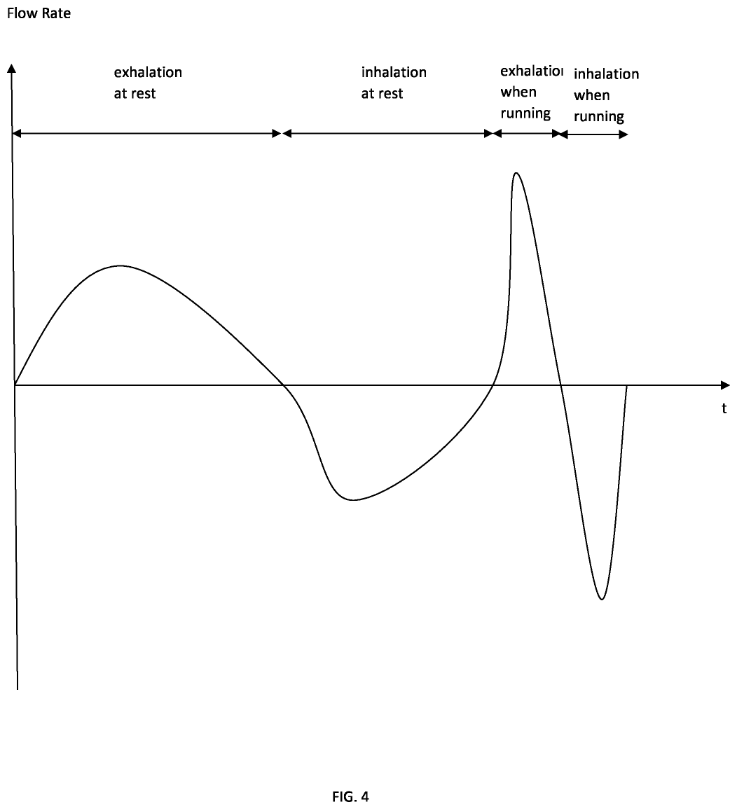

As an example, FIG. 4 depicts an exemplary graph of the flow rate of breathing (inhalation and exhalation) pattern or profile. As illustrated in FIG. 4, during exhalation, one starts her/his exhalation with a slow flow rate, then the flow rate increases higher and higher gradually, reaching a maximum value, and then slows down gradually until to a point when the exhalation ends. It is understood that, based on the behavior of the flow rate during the exhalation, it is possible to predict in advance the end of the exhalation, and thus the start of the inhalation.

Also as illustrated in FIG. 4, the inhalation behaviors similarly to the exhalation, but with possible different profile or curve. That is, during inhalation, one starts her/his inhalation with a slow flow rate (considering its absolute value), then the flow rate increases higher and higher gradually, reaching a maximum absolute value, and then slows down gradually until to a point when the inhalation ends.

It is to be appreciated that the breathing (both inhalation and exhalation) profile or curve varies for wearer's different physical movement conditions. For example, when one is at rest e.g. sitting down, the curve of the breathing (both exhalation and inhalation) profile or curve will be flatter, because one exhales and inhales smoother (i.e. with a slower flow rate) when at rest, which results in a smaller absolute maximum and a smoother curve at both the start and end of the exhalation and inhalation. On the other hand, when one is taking physical exercise e.g. running, the curve of the breathing (both exhalation and inhalation) profile or curve will be shaper, because one exhales and inhales faster (i.e. with a faster flow rate), which results in a larger absolute maximum and an steeper curve at both the start and end of the exhalation and inhalation.

It is understood that, because of the difference in inhalation profile or curve, it is necessary to adjust during the wearer's inhalation the amount of the air to be drawn into the protective face mask and its drawing rate, in order to maintain the positive air pressure in the protective face mask. In consideration of the above, during the wearer's inhalation the intake unit 38 provided on a protective face mask 30 is further configured to operate, i.e. draw air into the space between the inner side of the mask body 32 of the protective face mask 30 and the wearer's face, in accordance to the predicted inhalation profile or curve, in an embodiment of the present disclosure.

In an embodiment of the present disclosure, two intake units are provided on a protective face mask 30, one of which operates slowly with a large capacity, i.e. draws air slowly and is capable to draw a large amount of air, while the other one of which operates fast with a small capacity, i.e. draws air very fast but only draws a small amount of air. With these two different intake units, a prompt response is possible for the sudden change from a smooth or slow breathing to a fast breathing, or vice versa.

In order for the prediction on the start of inhalation and on the wearer's inhalation profile or curve, a sensor is provided on the protective face mask to detect or determine or estimate the flow rate of the wearer's inhalation and exhalation. In consideration of the correlation between the flow rate of the wearer's inhalation and exhalation and the air pressure in the protective face mask (in particular, in the space between the inner side of the mask body of the protective face mask and the wearer's face, a pressure sensor may be employed in an embodiment of the present disclosure.

As an example, a pressure sensor 50 may be provided in a protective face mask 30 to sense the air pressure in the space between the inner side of the mask body 32 of the protective face mask 30 and the wearer's face, in order to determine or estimate or predict when the wearer is breathing in/inhaling or breathing out/exhaling and/or the wearer's inhalation profile or curve, according to an exemplary embodiment of the present disclosure. In this exemplary embodiment, the intake unit 38 may be configured to draw air into the space between the inner side of the mask body 32 of the protective face mask 30 and the wearer's face based on the sensor signal from the pressure sensor 50. However, it will be understood by those skilled in the art that, the breathing in/inhaling or breathing out/exhaling and its profile/curve can also be determined by other conventional and known methods, which also fall into the scope of the present disclosure.

Although the embodiments above have been described in considerable detail, numerous variations and modifications will become apparent to those skilled in the art once the above disclosure is fully appreciated. It is intended that the following claims be interpreted to embrace all such variations and modifications.

The invention claimed is:

1. A protective face mask, comprising:
a mask body configured to cover a portion of a wearer's face;
securing means configured to secure the protective face mask to the head of the wearer; and
an intake unit configured to draw air into the space between the inner side of the mask body of the protective face mask and the wearer's face to maintain a positive air pressure in the space.

2. The protective face mask of claim 1, wherein the intake unit is configured to draw air from the outside environment and is equipped with a filter that is configured to filter the air drawn from the outside environment.

3. The protective face mask of claim 1, wherein the intake unit is configured to draw air into the space between the inner side of the mask body of the protective face mask and the wearer's face only when the wearer is breathing in or inhaling.

4. The protective face mask of claim 3, wherein the intake unit is configured to draw air into the space between the inner side of the mask body of the protective face mask and the wearer's face based on the prediction of the start of the wearer's inhalation.

5. The protective face mask of claim 1, wherein during the wearer's inhalation, the intake unit is configured to draw air into the space between the inner side of the mask body of the protective face mask and the wearer's face based on the wearer's predicted inhalation profile.

6. The protective face mask of claim 1, wherein two intake units are provided on the protective face mask, one configured to operate slowly with large capacity while the other one configured to operate fast with small capacity.

7. The protective face mask of claim 1, further comprising a sensor, based on whose signal the start and/or profile of the wearer's inhalation are predicted or determined or estimated.

8. The protective face mask of claim 7, wherein the sensor comprises a pressure sensor configured to sense air pressure in the space between the inner side of the mask body of the protective face mask and the wearer's face, thereby predicting or estimating or determining when the start and/or profile of the wearer's inhalation.
